(19) United States
(12) Patent Application Publication
(10) Pub. No.: US 2011/0066503 A1
(43) Pub. Date: Mar. 17, 2011

(54) System and Method for Transferring Digital Media

(75) Inventors: Rajesh Kanapur, Ypsilanti, MI (US); Chunhui Li, Mukiteo, WA (US)

(73) Assignee: CloudTrade LLC, Livonia, MI (US)

(21) Appl. No.: 12/990,172

(22) PCT Filed: Feb. 26, 2009
(86) PCT No.: PCT/US09/35295

§ 371 Date: Dec. 2, 2010

Related U.S. Application Data
(60) Provisional application No. 61/031,555, filed on Feb. 26, 2008.

(51) Int. Cl. G06Q 30/00

(52) U.S. Cl. 705/14.64

(57) ABSTRACT

A method is described that provides for selecting digital content and sending a download message to a mobile device. The method further includes sending a message from the mobile device using information from the download message to a download facilitation service. Additionally, the method includes initiating transfer from the mobile device from the download facilitation service, and transferring the digital content to the mobile device.

### RELATED APPLICATIONS

The present application claims priority to U.S. Provisional Application Ser. No. 61/031,555, titled “System and Method for Transferring Digital Media”, filed on Feb. 26, 2008, wherein the contents of the above mentioned application is hereby incorporated by reference in their entirety.

### TECHNICAL FIELD

The embodiments described herein are generally directed to a system and method for the transferring of digital media, and more particularly, to a system and method for transferring of digital media to mobile devices and/or user storage devices.

### BACKGROUND

Digital media is now commonplace in a user's everyday life and may include music, video, and data. The purchase of digital media, in particular music, is a common activity mostly in part due to the Internet. However, music purchases are tied to specific user computers. That is to say, when a user purchases music it is typically done from their personal computer where the content downloads (e.g., music files) are stored.

Existing digital media download systems are centered around an end-user's personal computer. For example, popular music downloading sites and services require that the user be at their personal computer to enable downloading. The music is ordered using a proprietary interface and then downloaded to the target hardware (e.g., the computer's hard drive) using the same interface. To transfer the music to a portable player the user must then create a playlist, synchronize music databases, or otherwise transfer the music to the portable player using a different functionality than the purchase functionality.

Other services may include requiring a user to bring a generic storage device (e.g., a USB FLASH drive or a SD card) to download digital media. However, the user would have to remove a memory device from the mobile device, plug the memory device into the local download portal, then remove the storage device and reinsert into the mobile device, requiring time and potentially creating failure of the mobile device or storage medium through repeated insert/removal operations.

Moreover, existing systems require that music be purchased through a portal and that the purchase is made from the user's personal computer to facilitate transfer of digital content. In other words, the user cannot be mobile or otherwise traveling while making music purchases. Such current systems prevent digital content purchases from kiosks or from computers other than the user's computer.

Other digital content purchases require multiple steps to accomplish downloading to a mobile device. A first step may include a user clicking on a link to get the content. A second step requires the user to log-in to a download service. A third step requires a check-out process where the user either validates that they want to purchase the content (after logging in to identify themselves) or to input their payment method. A fourth step may include looking at the mobile device to provide a password sent after step 3 (to verify that the user's device is properly identified). A fifth step includes typing the password from the mobile device into the portal input to complete the purchase. Such multi-step purchasing of content is burdensome, wastes valuable time, and requires transfer of information, manually by the user, from one system to another.

Additionally, the multi-step process as described above are used with a single portal, typically under the control of a content seller. The content seller provides a single portal for the user to go to, select content, then proceed through a multi-step process to download the content to the phone. However, such single-source systems do not provide for differentiation in the market or allow for numerous locations to provide the digital content. Indeed, the content sellers include single-source e-tailing.

Mobile devices, such as cellular phones, music/video/photo devices, and PDAs, have become a part of the digital media world. Unfortunately, there is no easy way for users to directly receive digital content for these devices. Thus, there exists a need for a direct downloading of digital media to a user's mobile device or to a user's general storage. Moreover, there is a need for users to download music to a mobile device requiring little effort. Additionally, there is a need for a digital content distribution system that support multiple sites providing content.

### BRIEF DESCRIPTION OF THE DRAWINGS

The features and inventive aspects will become more apparent upon reading the following detailed description, claims, and drawings, of which the following is a brief description:

FIG. 1 is an example of a system for content storage and sharing.

FIG. 2 is a trading platform that includes systems and functional components that cooperate with the content storage and sharing system of FIG. 1.

FIG. 3 is a system architecture for use with system of FIG. 1.

FIG. 4 is an example of an application sharing flow diagram for use with the systems and methods described herein.

FIG. 5 is an example of a local trading flow diagram for use with the system of FIG. 1.

FIG. 5A is a flow diagram for content sharing between two users.

FIG. 6 is an example of a remote trading flow diagram for use with the system of FIG. 1.

FIG. 7 is an example of a first version of a pay-per-click flow diagram for use with the systems and methods described herein.

FIG. 8 is an example of a second version of a pay-per-click flow diagram for use with the systems and methods described herein.

FIG. 9 is an example of a third version of a pay-per-click flow diagram for use with the systems and methods described herein.

FIG. 10 is a diagram of a points system for use with the system and methods described herein.

FIG. 11 is an architecture for “one click” digital content transfer system.

FIG. 12 is a flow diagram for “one click” digital content transfer method.

FIG. 13 is an architecture for a multi-site digital content transfer system.

FIG. 14 is an architecture for a single-site digital content transfer system.

### DETAILED DESCRIPTION

Referring now to the drawings, illustrative embodiments are shown in detail. Although the drawings represent the embodiments, the drawings are not necessarily to scale and certain features may be exaggerated to better illustrate and explain novel aspects of an embodiment. Further, the embodiments described herein are not intended to be exhaustive or otherwise limit or restrict the claims to the precise form and configuration shown in the drawings and disclosed in the following detailed description. The present application claims priority to U.S. Provisional Application Ser. No. 61/031,555, titled “System and Method for Transferring Digital Media,” filed on Feb. 26, 2008, wherein the contents of the above mentioned application is hereby incorporated by reference in their entirety.

Examples of methods and systems for content storage and/or content sharing are discussed herein. Although the examples may be discussed in reference to particular systems and architectures, one skilled in the art recognizes that the systems and methods may be employed in a variety of architectures that may be interchangeable. Moreover, while there may be particular features associated with the “trading” of content and different features associated with the “sharing” of content, unless specifically limited, the use of “sharing” and “trading” may be used interchangeably to indicate the location (e.g., searching/finding of content) and and/or transfer of content from one user to another.

In general, the method and system for content storage and/or content sharing includes at least one interface to a user to upload, download, and trade digital content. A typical example of content trading includes digital music. In order to provide a legal trading system, using a royalty system, all digital content that is traded from one user to another is identified and the appropriate royalties are paid to the licensor. For example, where digital music is traded, the song(s) are identified by the royalty system and the appropriate royalties are paid, for example to the record company and/or artist.

The trading system also allows for personal storage of digital content in a locker. The locker may be a digital storage system 120 (e.g., a repository for digital content) that allows the user to upload and download content. Moreover, based on the user's direction, the user's digital content may be searched and traded by other users. For example, the user may label certain digital content as “private”, “public”, or provide access to “groups” of defined users. When a user defines content as “private” this means that the content is not available to other users for search or sharing. When a user defines content as “public” this can mean that “any” user may search and share the content. When a user defines content as available to a “group”, then the user may select an already existing group of users or they may create a group that may be defined by one or more users. As an alternative to labeling the digital content individually, the user may have folder or other repositories set up to receive digital content that label automatically provides access rights to the “private”, “public”, and/or “groups” to simplify the determination of access rights.

An advertisement system may place advertisements for users to view before certain actions take place. In one example, advertisements may be inserted and viewed by a user before content upload or download takes place. In another example, advertisements may be shown during trading of content. In yet another example, advertisements may be shown before a search is performed on another user's content. As is understood by those skilled in the art, advertisements may be placed for viewing by a user at any action the user takes. By viewing the advertisements, the user may accumulate points or other benefits.

When using mobile devices, the user may synchronize the mobile device with the main system in order to transfer points that may be stored locally on the mobile device to the main account.

In general, a user may create an account and upload digital content to a database. This upload may be accomplished, for example, through a mobile device, web-portal, or other capable system (e.g., a music library, a personal digital content server, etc.). The user may then manage and organize their content for themselves and/or for sharing with other users. When using a mobile device, the user may install a mobile portal (e.g., software local to the mobile device) to manage their account or use a web interface. The mobile portal may also be configured to allow direct sharing with other user's mobile devices through networks such as Bluetooth®. Alternatively, the user may share or trade digital content through the use of networking protocols such as Wireless Access Protocol (WAP).

The user may acquire points by trading content, viewing advertisements, taking action (e.g., such as clicking or following a link, placing a call to a sponsored number, downloading content and/or advertising), and/or direct purchase. Points may be considered a currency of sort that may be used in the virtual world. Points may be accumulated by a user, for example, by trading, viewing of advertisements, or contacting advertisers. The points accumulated by a user may be redeemed for more storage space or, for example, gift cards to merchants or tickets to movies or events (concerts).

The content owner may also track their points and traded/shared content. Typical content, such as music, may be tracked by ID3, WMA, or other metadata associated with the digital content to determine the content owner.

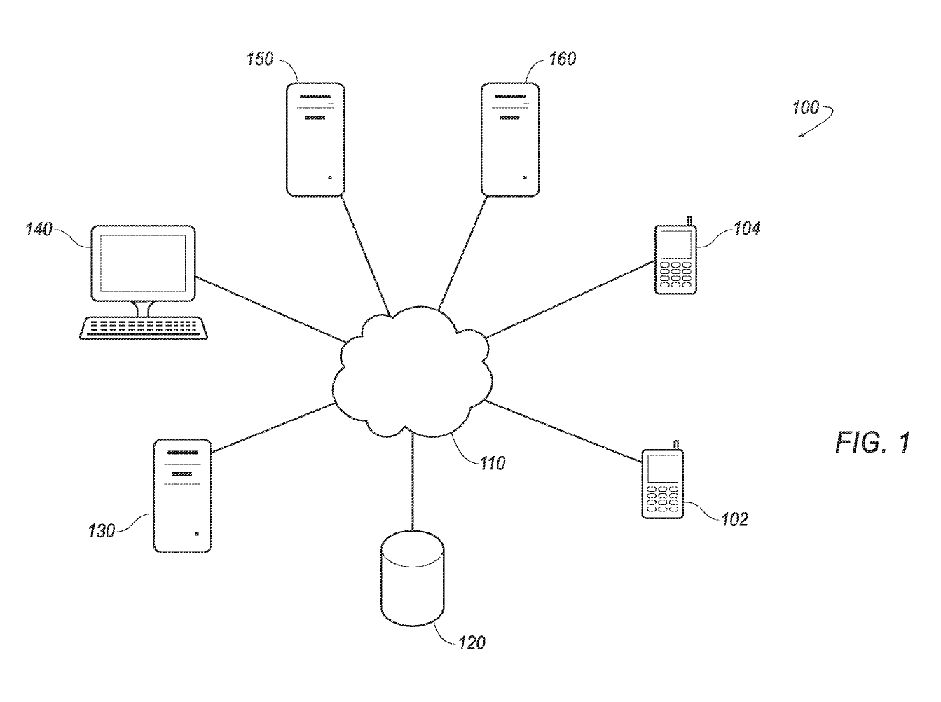

FIG. 1 is an example of a system 100 for content storage and sharing. System 100 includes a first mobile device 102 and a second mobile device 104 connected through a network 110. System 100 may be described as a multi-layer set of interfaces, services, and persistent data stores. Mobile devices 102, 104 may include communication devices, e.g. phones, and other devices that are capable of connecting to network 110. Network 110 may include multiple types of networks and is generally intended to provide data connectivity. For example, network 110 may include public, private, and personal networks, including for example, wireless networks (e.g., Wi-Fi, blue tooth, etc.), wired networks (e.g., ATM, Ethernet, etc.), optical networks, and any combination thereof. Such combinational networks may be considered a hybrid network, for example, where digital, analog, wired, wireless, and/or optical transmission mediums may be employed to communicate data to either of mobile devices 102, 104.

System 100 also may include a storage system 120, a system server 130, a terminal 140, an advertisement server 150, and royalty server 160. Storage system 120 includes persistent storage of user data. In examples of system 100, storage system 120 may include multiple storage hardware devices that may be located together (entirely or in part) or separate (entirely or in part), depending upon the network structure, user accessibility requirements, or other system requirements. Storage system 120 may also include user content (e.g., digital content such as digital music or other files) and user information (e.g., demographics and transaction history).

System server 130 is typically configured to provide the business logic for system 100 and may be used to administer system 100, including user device provisioning (e.g., mobile device 102), account maintenance, tracking of points, and management of digital content. Users may create a registration and manage their digital content, share content, and trade content using an interface to system server 130. Terms for the trading of digital content and transaction tracking may be built into system 100 as provided by system server 130.

Terminal 140 shows a generic interface to system 100 that the user may upload and trade digital content. For example, terminal 140 may be a personal computer connected to network 110 via the internet. Advertisement server 150 may be used to provide advertisements to the user during the use of system 100. Royalty server 160 may include systems to access a copyright owner's systems for reporting transactions and to provide information regarding users' trades.

In general, as discussed herein, user content may also be termed digital content and may include, for example, music, video, documents, or other digital data. When copyrighted materials are traded, metadata about the digital content may be recorded and stored by system 100 (or another system in communication with system 100 for recording transaction information or content information). This information may include title, artist, and publisher information. Using this data, system 100 may properly accredit the copyright holder with license fees. In this way, system 100 provides a legal system for trading of digital media.

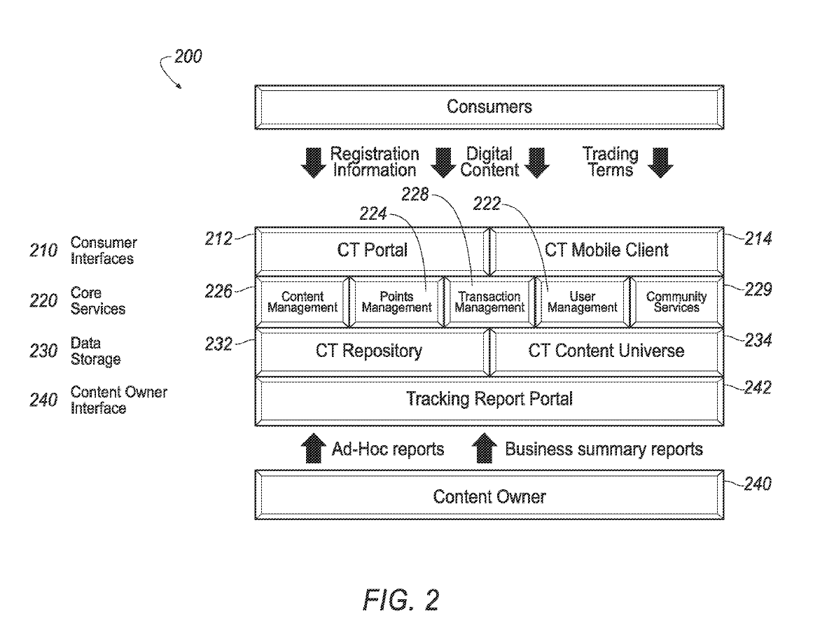

FIG. 2 is a trading platform 200 including system and functional components that cooperate with system 100 of FIG. 1. Trading platform 200 also cooperates with advertisement server 150 to generate revenue through the use of advertisement insertion in the trading of digital content. Trading platform 200 also provides a benefit to users and digital content owners by enabling users to monetize their digital content through trading. The user may be further benefited through the accumulation of points (e.g., accumulation of revenue) through viewing advertisements and/or the user receiving the content viewing advertisements.

A consumer interface layer 210 may include a portal 212 and a mobile client 214. Portal 212 may be used with, for example, terminal 140 of FIG. 1 using a generic terminal that accesses network 110. In an example, portal 212 may be a web-based portal application providing users access to system 100 using typical web-browsers (e.g., Internet Explorer, Firefox, Safari). Portal 212 provides general system access including registration, account management, content management, content search, transactions, transaction history, and other features provided by system 100.

Mobile client 214 may include a set of “Off Deck” mobile applications with similar functionality to portal 212, but with additional features tailored to the mobile environment such as sharing via personal area networks (e.g., using Bluetooth). In general, mobile client 214 may be downloaded to a mobile device (e.g., mobiles devices 102, 104) and may be customized for the particular operating system used by the mobile device (e.g., Symbian OS, Windows Mobile, BREW, etc.). Alternatively, mobile client 214 may be configured as a generic application using cross-platform technology (e.g., JAVA).

Mobile client 214 may also provide special capabilities given that the performance of mobile device 102 (e.g., in data connection, bandwidth, and storage space) may not be as robust as those provided by terminal 140 (using portal 212). In an example, the storage space available for mobile device 102 may be limited. Thus, mobile client 214 provides for storage on the mobile device itself or on expansion memory (e.g., an SD card). Moreover, mobile client 214 may allow for asynchronous processing that provides the functionality to users to download content while they are trading. Additionally, if there is an interruption in data service, mobile client 214 may provide for continued downloading from the point of interruption rather than restarting the download transaction.

A compilation of core services 220 provide various services for the support of system 100 that may include content. In general, core service 220 provides for content management, transaction management, point management, user management and general services for the user community associated with system 100. Core services 220 may include “middleware” that may use, for example, the “Java 2 Platform, Enterprise Edition” (J2EE). J2EE includes standards for enterprise applications that provide for modularization of components that include full support services with minimal coding. As an example, middleware (including core services 220) may be executed on, for example, system server 130 of FIG. 1. System server 130 may include a JBoss application server that allows core services written in J2EE to be executed for the operation of system 100. However, as is known to those skilled in the art, the particular implementation of system 100, including core services 220, may not be not tied to a particular system architecture or software environment. Thus, the examples described herein using J2EE and JBoss are merely exemplary of a typical implementation.

User management system 222 offer services to the user to register (e.g. sign up for) an account using portal 212 or mobile client 214. When registering through portal 212, and once system 100 accepts the registration as complete and accurate, a message with a download link may be sent to a user's mobile device (e.g., mobile device 102). The user may then install mobile client 214 to their mobile device by clicking on the link and downloading an installation package for mobile client 214. Alternatively, the user may download mobile client 214 to mobile device 102 using services such as a USB connection or using services such as ActiveSync or other connectivity solutions provided by the mobile device manufacturer.

Registration may also be performed through mobile client 214 directly from mobile device 102. For example, mobile client 214 may be transferred from another mobile device (e.g., mobile device 104) through direct sharing, using a network (e.g., Bluetooth) or by providing a download link through, for example, a SMS text message or e-mail. Once installed, mobile client 214 may then be used to register the new user directly from their mobile device. Alternatively, the user may perform registration by entering the mobile phone number and e-mail address to initiate signing up for the services of system 100. The user then receives a download link by e-mail or SMS message from system 100 and the new user can install mobile client 214 by clicking on the link.

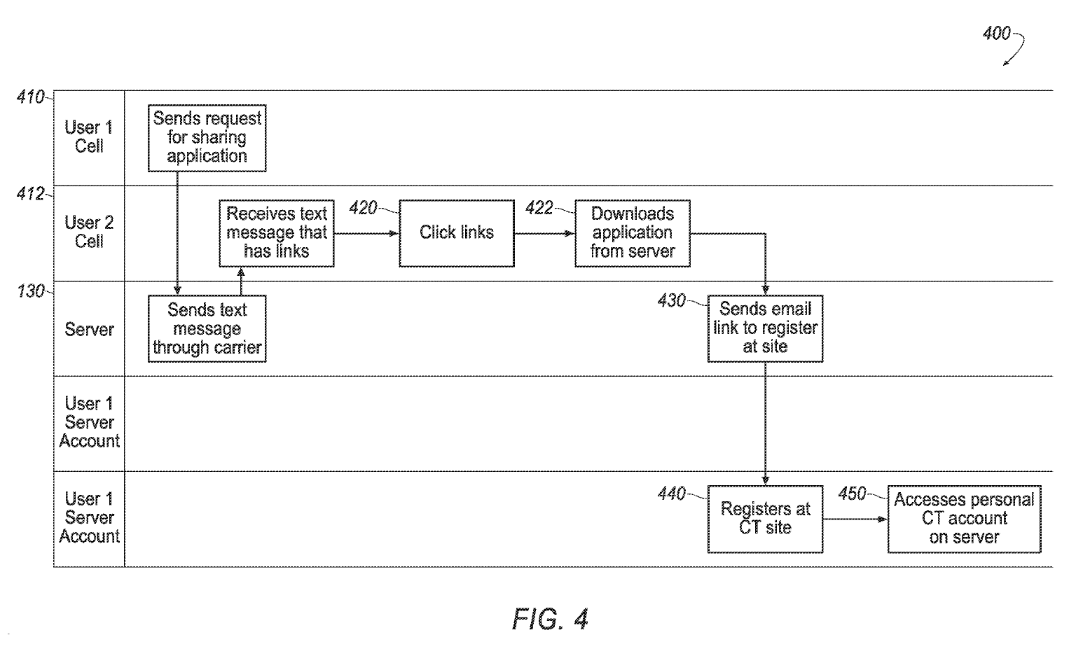

FIG. 4 is an example of an application sharing flow diagram 400 for use with the systems and methods described herein. A first user 410 may initiate sharing mobile client 214 with a second user 412 by requesting mobile client 214 be sent to second user 412 by system server 130. Second user 412 then receives a message that contains a link to mobile client 214. Second user 412 then clicks the link 420 and downloads 422 mobile client 214. Second user 412 then sends registration information 430 to register 440. The user then may access 450 the user's new account and being digital content upload or trading.

In the deployment of mobile client 214, the “Over the Air” (OTA) methods allow for application versioning and upgrade capabilities. Trading platform 200 may include client-side and server-side authentication through checking of credentials before a user can use the services of system 100.

Point management system 224 may include user incentive systems based on virtual points to enable the user to monetize their digital content through trading of the content with other users and/or the viewing of advertisements to obtain points. The point system allows users to acquire additional digital content through system 100, to enable the initiation of trading transactions through mobile client 214 and/or portal 212, and to acquire additional storage space in system 100 for their digital content.

In particular, points may be acquired by the user by the trading of digital content, initiation of advertisements (e.g., through trading) or upload/download of digital content, and prepaying for points (e.g., using mobile client 214, portal 212, and/or other accounts such as PayPal or Google Checkout). When the user aggregates points, they may redeem their points for “Gift cards”, “Movie Tickets”, etc. If mobile client 214 is not connected, for example, to system server 130, then points are accumulated locally on mobile device 102. The user may then synchronize points from mobile client 214 to system server 130 by uploading (depositing) the points from mobile client 214 to their account. The user may also download (withdraw) their points from their account to their mobile client 214 to allow for localized trading when not connected to system server 130. The storage of points on mobile device 102 allows for direct trading of local content with other mobile devices (e.g., mobile device 104).

A content management service 226 allows users to manage their content. For example, a user may “upload” or “download” digital content to their account from their terminal 140 (e.g., computer) using portal 212 or through their mobile device 102 using mobile client 214. Moreover, content management service 226 also allows a user to search using portal 212 and/or mobile client 214. The search may include searching the user's own digital content or the content of other user's that have provided access to their digital content to the particular user or the community. The search functionality provides one method to identify digital content of others for initiating trading.

Search functionality may be provided for any number of different scenarios. In a first example, a user may search their own content by title, content type (e.g., music, video, documents, etc.), date, and other parameters or metadata that may describe the content. In a second example, a user search/locate others' content by using general “find content” functionality. One example includes a public search that is able to search public content from other users. For example, a user may search for a particular song title, and all public content from other users is searched. Another example includes a “browse” function that limits the search to “friends” or “groups”.

When using the “browse” functionality, a user's “friends” or “groups” appear for selection. The user may then pick a friend, group, or combination thereof and connect to their locker(s). The user then inputs the search information and begins the search of the connected lockers to discover content that matches the search information. Content from the “friends” and/or “groups” then appears for selection and trading.

When the user is presented with content matching the search information (e.g., search results), they may further narrow the search by “ratings” of the content. For example, the search results may include the title of the content, the size of the content (e.g., “title . . . 1.2M”), the encoding type (e.g., MP3), and the length of the content (e.g., 3.2 minutes). In the case of music content, this allows the user to judge whether the content is indeed the content searched for. Moreover, a rating system may be employed that allows users to rate the content after they have sampled it. Where certain content is very popular, it may receive a high rating (e.g., five stars). Other rating systems may be employed that use the number of trades for particular content, or a hybrid system that may include a formulaic approach having inputs of user rating and number of downloads.

A transaction management service 228 provides functionality for trading and tracking of trades. Transaction management service 228 generally enables users to use mobile client 214 to share or trade their digital content in close proximity through Bluetooth technology (local trading) or long distance using WAP (remote trading). Transactions initiated by mobile client 214 are stored within mobile client 214 until the transaction history information is synchronized with the system server 130. The synchronization may be initiated by the user or by transaction management service 228 after a defined number of transactions.

Transaction management service 228 assists in capturing the copyright information such as author, publisher, etc. from the digital content during trading activities of copyrighted content. Transaction management service 228 may also be used by mobile client 214 during local trading and may be used on system server 130 during remote trading. The transaction information collected during trading may be saved as part of the transaction history. One example of such a collection of transaction information may include the extracting of metadata to identify potential copyright information related to the digital content (e.g., MP3 files and WMA files). Transaction management service 228 generally extracts the metadata information from an ID3 tag embedded in MP3 files and tag embedded in WMA files.

Although collection of transaction information using metadata collection methods may not be able to prevent users from modifying the tag information, other methods may be employed to make the system more robust for determining the correct copyright information. For example, transaction management service 228 may include the capability to detect modification of tag information by validating the user's tag information for digital content with other metadata repositories. Another example of detection may include employing a digital content fingerprinting service to particularly identify digital content. Using, for example digital fingerprinting, the transaction history information and the signature information may be captured and stored on system server 130. Using this collected information, system server 130 may generate a trading activity report for the content owner.

Community services 229 may provide general services for the users such as blogging, grouping, and social networking through portal 212 and/or mobile client 214. In addition, services such as bulletin board-type services allow a user to promote their digital content for trading and may be used for mass messaging of content availability.

A data storage system 230 may be provided as a persistent storage system using, for example, storage system 120 of FIG. 1. A user repository 232 may include a relational database used to store information about each user, the user's content, and transaction information. A content universe 234 may include a file system to store the user's digital content.

A content owner interface 240 may include a tracking reporting portal 242 that may include a web-based portal application. The content owner may then access their reports using an ad-hoc reporting system or business summary report.

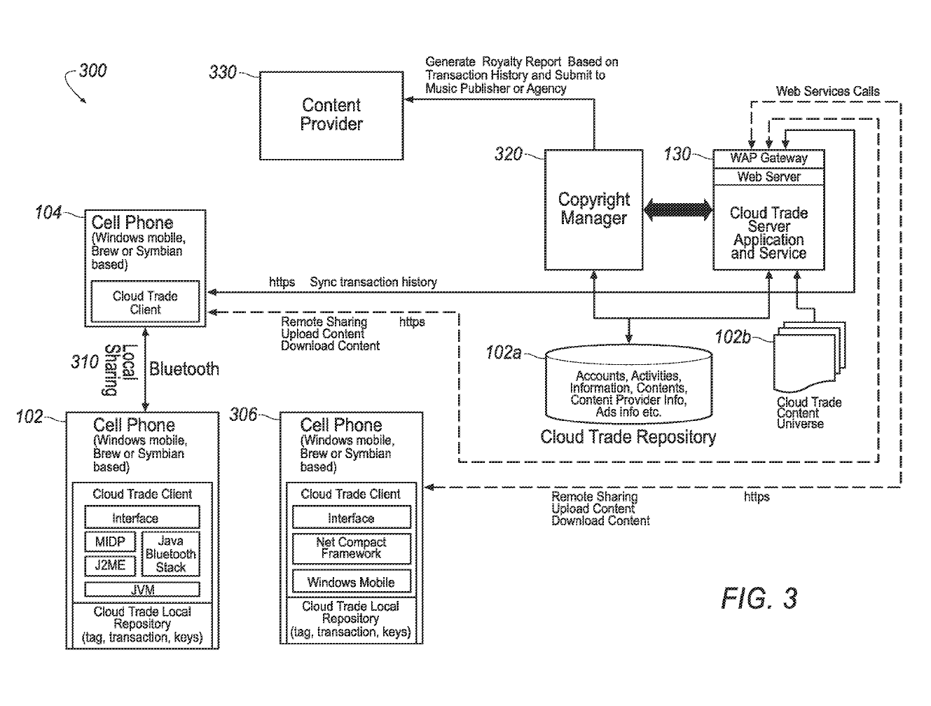

FIG. 3 is a system architecture 300 for use with system 100 of FIG. 1. In general, system 100 (see FIG. 1) and trading platform 200 may include a “rich client” operating on mobiles devices (e.g., a cell phone) and server application/services operating on system server 130. The clients, such as mobile client 214, may be developed using different technologies that are suitable for the different types of operating systems found on the mobile devices. For example, mobile client 214 may be developed using Windows Mobile for a particular mobile device 102 where the implementation is based on Windows .Net compact framework (e.g., .Net compact framework 2.0). Where mobile client 214 is configured for the Symbian OS, it may be developed based on J2ME technology (CLDC 1.1, MIDP 2.0, JSR 82, JSR 75, kSoup etc.). In another example, where mobile client 214 is configured for a Brew system, it may be developed based on C++ library provided by Brew.

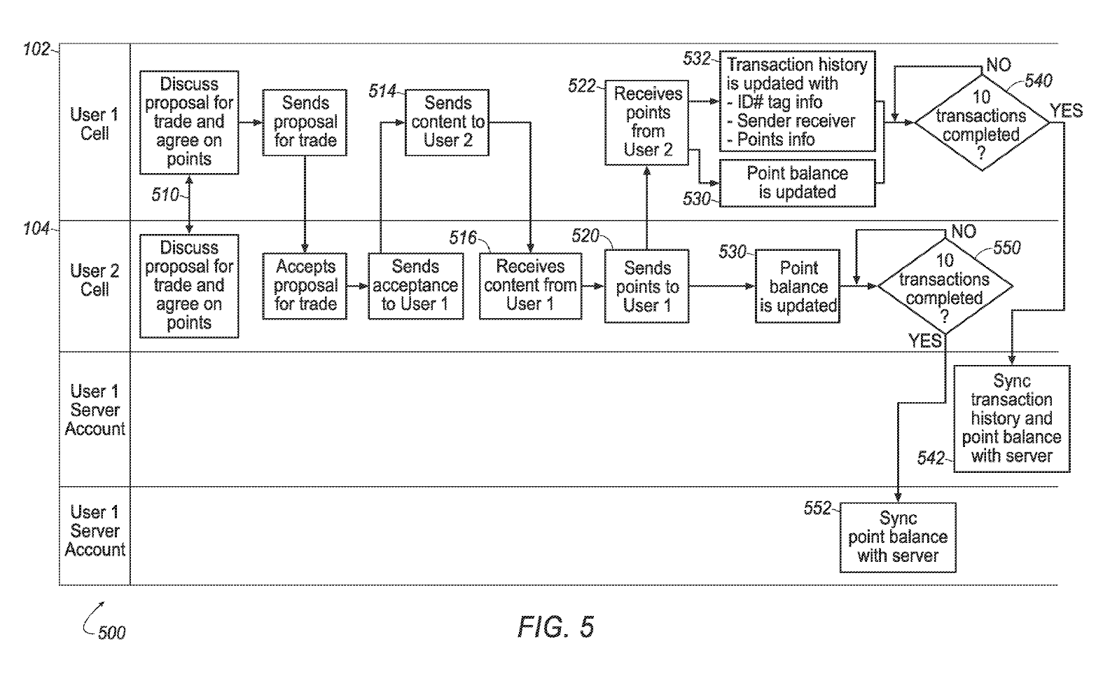

Local sharing between mobile devices 102, 104 is shown using Bluetooth communications 310 (also described below with respect to FIG. 5). However, other communication systems may be used to provide direct communication of mobile devices 102, 104. Moreover, local sharing may also include sharing using other networks that allow for point-to-point communication between mobile devices 102, 104 but not direct communication. For example, the devices may use the internet, accessed by wired or wireless means, to communicate directly with each other using a proxy server or point-to-point communication (but not using system server 130). Such systems, although not enabling direct communications, also fall under the category of local communications. Remote communications are shown by mobile devices 104, 306 as communicating through system server 130.

Storage system 120 is shown in FIG. 4 as divided into an account repository 120A and a content universe 120B. Although they are shown divided, each may be part of the same storage system or network, or they may be divided. As one skilled in the art will appreciate, the physical storage medium and location of account repository 120A and content universe 120B may be configured in many ways.

A copyright manager 320 tracks trading of digital content so that the proper content owner may be credited. For example, copyright manager 320 may include portions of content management service 226, transaction management service 228, and tracking reporting portal 242 (see FIG. 2). By tracking the owners of copyrighted materials, and the trades that occur between users, system 100 provides a legal trading platform for the exchange of copyrighted digital content. Ultimately, where appropriate, a content provider 330 (e.g., a content publisher, content owner, content licensor, content licensee, or other provider or licensing entity) may be credited with a license fee based on the trading of copyrighted material between users.

As described herein, local trading includes trading that takes place between two mobile devices 102, 104 without access to system server 130. This may be accomplished through local networking services such as Bluetooth but is not limited to such an implementation. An example of a local trading flow diagram 500 is shown in FIG. 5. A first user may use first mobile device 102 to initiate a trade with a second user and second mobile device 104.

In local trading, first mobile device 102 may initiate a discussion 510 between users about the proposal for a trade of digital content and the agreed upon points. Once decided, the first user may send a proposal 512 for trade to the second user. The second user may then accept proposal 512 and the first user may initiate the transfer of digital content 514 to the second user. The second user then receives 516 the digital content. For the transfer of digital content, the agreed upon points are sent 520 from the second user and received by 522 the first user. The points balances for the first and second users are then updated 530. Additionally, the transaction history (including identifying data regarding the content traded) is stored for later synchronization with system server 130 for accounting and royalty payment purposes. If the first user has accomplished a predetermined number of transactions 540 (in this example, 10 transactions), then the transaction history is synchronized 542 with system server 130. Similarly, when the second user has accomplished a predetermined number of transactions 550 (in this example, 10 transactions), then the transaction history is synchronized 552 with system server 130.

FIG. 5A is a flow diagram for content sharing between two users. In terms of process, “sharing” may be distinguished from “trading” in that bartering between users does not place. The system may be configured so that “sharing” may provide for a user to search other user's lockers to find content. When the desired content is located, the user may then simply request the transfer of content without the other user's interaction or assent. Of course, the user providing the content would have allows for the requesting user to be allowed access to the content (e.g., by way of permissions). Other sharing systems may employ a software agent (e.g., an auction agent or avatar) that may not require user input.

User 1 determines that more content is desired and selects a search method 560. The user may choose to search “public”, “groups”, “friends” or any combination thereof. When, for example, the user selects “public” and “groups” or “friends”, the search results will include both public and restricted content. When, for example, the user knows that their “friends” have a particular content file then it may allow a more focused to search to exclude “public” content that might otherwise clutter the search results.

A query 562 may then be made for content residing in the chosen group(s)/friend(s) or public repositories. Query 562 connects with the appropriate locker(s) to access content with the appropriate permissions (e.g., public/group/friend) and sends results 570 back to user 1. User 1's mobile device may then display the results 572 at mobile client 214 (see FIG. 2). Alternatively, the results may be displayed at a portal (e.g., 212 of FIG. 2). With the content displayed, user 1 may select the content 574 for sharing using name, size, rating, etc. User 1 then initiates content sharing 580 and the transfer process begins from user 2's locker to user 1's locker. User 2 receives points 582 for providing the shared content. User 1 may watch an advertisement 590 or may use points to receive the content (not shown). At the same time the advertisement is displayed, the user may receive the content 592 over any variety of networks. In general, the advertisement may be displayed to the user before the transfer of content, during the transfer of content, and/or after the transfer of content. Moreover, advertisements may be used before, during, and/or after a content search is performed.

Other examples of sharing and/or trading may be predicated upon search algorithms and/or heuristics for determining the user's desired content. For example, the user may employ the search methods described above that may take into account the desired quality (e.g., minimum quality) of the content, the size (e.g., storage space required), cost (e.g., currency, points, advertisement viewing, etc.), operator ratings (e.g., determined by system 100), general user ratings, specialized ratings developed by the user searching, or other factors (e.g., whether “cover art” is provided in the case of music content). The user may search for content and the content may be presented as ranked by the user's criteria to provide them the most relevant content based on their desirability parameters.

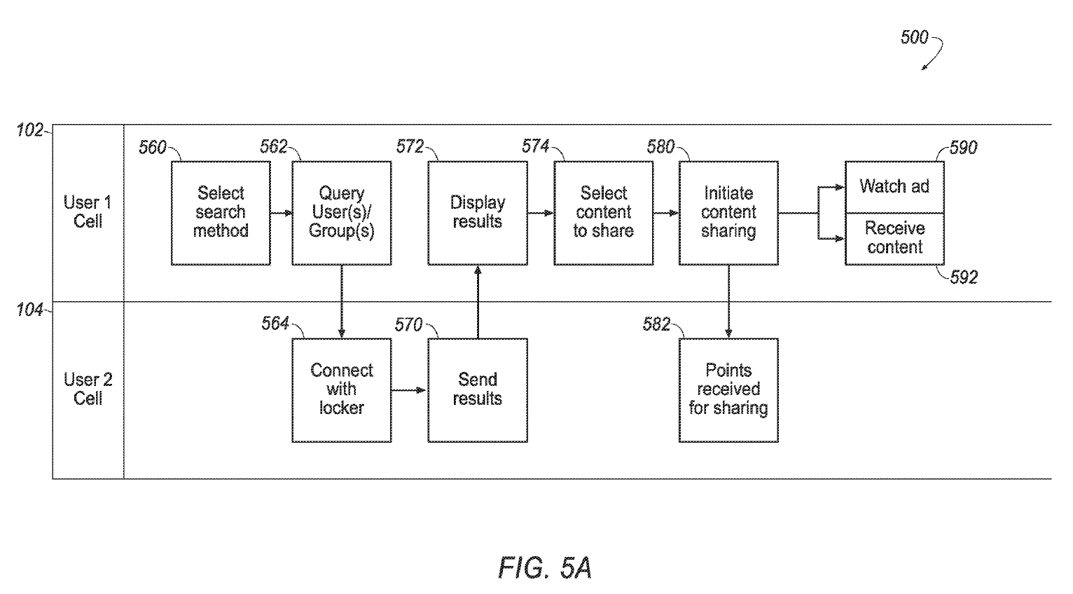

An example of a remote trading flow diagram 600 is shown in FIG. 6. In remote trading, the requests and digital content are typically provided by system server 130 and/or storage system 120. First mobile device 102 may initiate a discussion 610 between through system server 130 to second mobile device 104 about a proposal for a trade of digital content and the agreed upon points. The second user may accept of decline the proposal 620. If accepted, the second user sends the acceptance 622 to the first user. System server 130 then sends 624 the digital content agreed upon to the second user. The trade status is updated 626 to reflect the reception of the digital content. As with the local trading of FIG. 5, the points balances for the first and second users are then updated 530. Additionally, the transaction history (including identifying data regarding the content traded) is stored for later synchronization with system server 130 for accounting and royalty payment purposes. If the first user has accomplished a predetermined number of transactions 540 (in this example, 10 transactions), then the transaction history is synchronized 542 with system server 130. Similarly, when the second user has accomplished a predetermined number of transactions 550 (in this example 10, transactions), then the transaction history is synchronized 552 with system server 130.

In addition to providing a storage and trading platform, system 100 may also provide security on multiple tiers. For example, user accounts and user content are protected as well as the publisher's copyrighted content. User authentication may be used on both mobile client 214 and portal 212 before access is granted to a user account or to user content. Users are to be authenticated and “logged in” before they access their accounts or use mobile client 214 to trade content.

During local trading (e.g., using Bluetooth), mobile client 214 may include security measures based on, for example, RFCOMM and Service Discovery Protocol. During the “pairing” of mobile devices 102, 104, the PIN exchange may occur first to enable the authentication of each mobile device 102, 104, followed by the data being exchanged. Data encryption may also be implemented during the data exchange. During local trading, the identifying information of the digital content (e.g., ID3 tag information, content title, publisher, etc.) may be captured for the transaction history and saved at mobile client 214 for future synchronization with system 100. Once connected to system 100, mobile client 214 uploads the transaction and traded content information to system server 130 for the records and for report generation. Encryption at mobile client 214 may also be used to encrypt user account information, passwords, point balance, transaction history, etc.

During remote trading using mobile client 214, users may exchange digital content using wireless application protocol (WAP) and the data may be transferred using, for example, HTTPS protocols to securely connect with system server 130 and storage system 120, etc. Similarly to local trading, signature information and content information may be captured for the transaction history and saved to system server 130.

In general, alternative embodiments may include mobile devices, web-portals, computers, and any combination thereof. To facilitate the sharing or trading of digital content, a central server (e.g., system server 130) may be employed to deliver digital media. However, if two mobile devices (e.g., mobile devices 102, 104 of FIG. 1) are used to trade digital content directly, they may use short-range wireless technology (e.g., Bluetooth) to communicate the digital content. If short-range wireless technology is not available or is not desired for use, the mobile devices may use any network to communicate to system server 130 to trade digital content.

Along with the storage and trading of digital content, the tracking of any trading may be recorded. For example, where music files are traded between users, the system may keep records of the transaction and the digital content being traded. For example, metadata related to the digital content may be recoded so that the proper licensors may be compensated for digital content traded to another user. Each time a transfer occurs, the information from the digital content is recorded so that the number of times each particular file has been traded can be accounted for. The individual trade, or the aggregate trades, may be used to determine a royalty or license payment to the content owner (e.g., the copyright holder).

In another aspect, an advertising system my interject advertisements into the trading, uploading, downloading, or playing of digital content. For example, the advertisement system may include advertisements when a file is uploaded or accessed by a user. Moreover, the system may show an advertisement with each trade of digital content to offset the costs of payment to the content owner. These advertisements may also provide points to the user for watching them. Depending upon the user information collected (e.g., location or demographics), the advertisement system may also tailor the advertisements to the particular user. This may have value-added benefits to the advertisers or potential advertisers so that they may use targeted advertisement methods to provide more relevant advertisements to the user.

Generally speaking, the advertisement system may include certain advertisement methods including pay-per-click, pay-per-call, and pay-per-view. When using the pay-per-click advertising method, the user's mobile device may be loaded with banner advertisements. If targeted advertisements are used, the banners may be chosen based on the profile of the user. Along with the advertisement, there may be a link that takes the user to the advertiser's site. For each click-through made by the user, the advertiser is charged a certain fee for the advertisement.

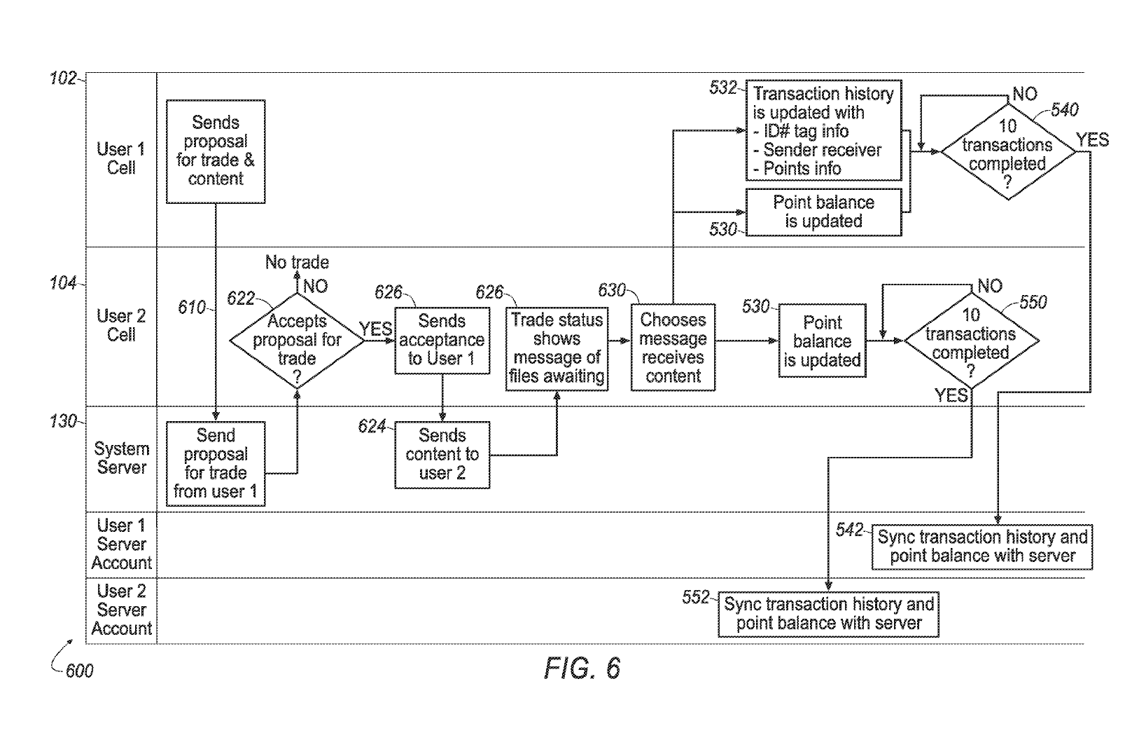

In the pay-per-call method, there are typically three main variations. Each variation provides that the user's mobile device may be loaded with banner advertisements from the server. The user then views the banner when logging-in to the application and selects the banner of greatest interest. In the first variation, the selection then initiates a call to be placed directly to a number chosen by the advertiser, typically a store or call center operated by the advertiser (see FIG. 7 as an example of a first version of a pay-per-click flow diagram for use with the systems and methods described herein).

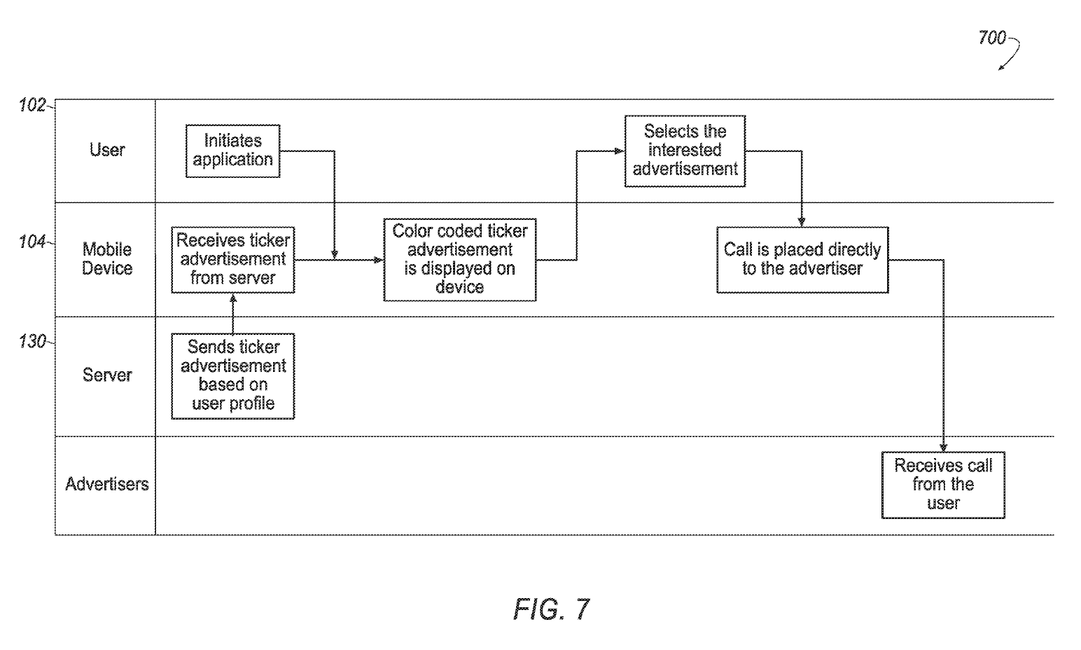

In the second version, the selection initiates a 1-800 call to the server that in turn diverts the call to the advertiser (see FIG. 8 as an example of a second version of a pay-per-click flow diagram for use with the systems and methods described herein). As discussed herein, the “click” system may include not only a user's clicking a link to take them to an advertisement or storefront, but the “click” model may also include calling, and downloading content. the content may include, for example, a ring-tone (e.g., for a phone), a background (e.g., for a display device), music content, video content (e.g., a clip), or other content accessible by the user's device.

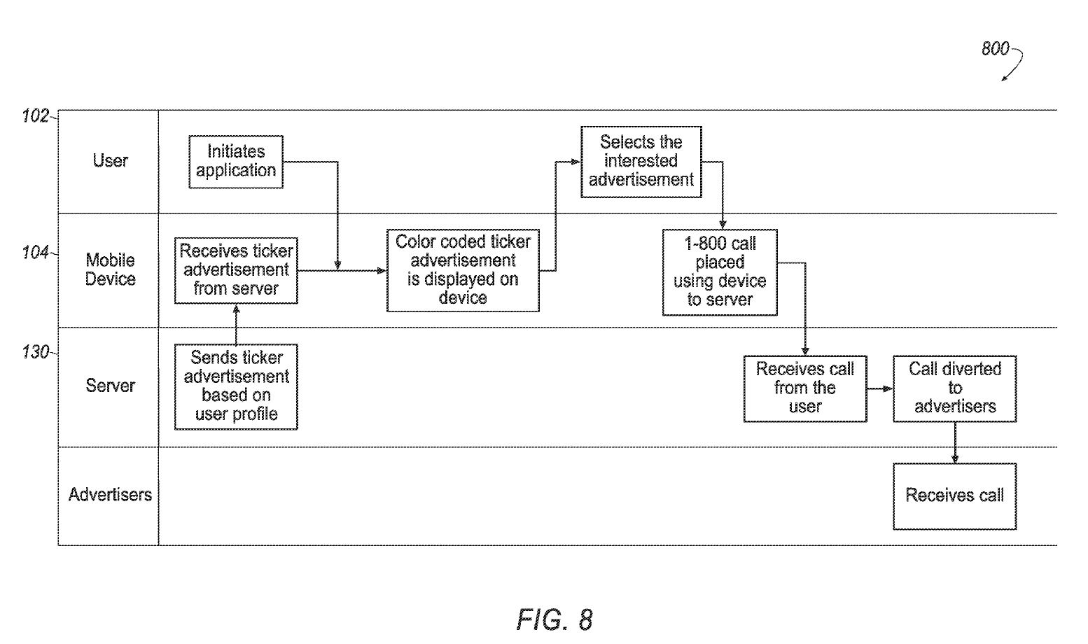

In the third variation, the user's selection sends an authorization to accept calls from the selected advertiser (see FIG. 9 as an example of a third version of a pay-per-click flow diagram for use with the systems and methods described herein). The authorization is received by the system and the sales-lead is passed on to the advertiser.

In the pay-per-view method, the user's mobile device may include a bulletin message from the server based on the profile of the user. The user then may view the bulletin and may click the message to download the content. Once downloaded, the user may view the content. Points may be given to the user for viewing the advertisement, clicking the link, downloading content, and/or viewing the content. Indeed, where an advertisement is initially interesting to a user, the further the user investigates the advertisement (e.g., by requesting more information, viewing other advertisements or similar advertisements, contacting the advertiser, or visiting the advertiser's storefront) the more points may be accrued. Moreover, the further the user investigates an advertisement, the number of points may be increased according to the depth of the user's investigation.

An example of how content may be linked to the pay-per-click method may include music related to an advertisement. When or after an advertisement is shown, the user may be provided a number of links that may include a link to the advertiser's storefront or a link to the music played (e.g., background music) during the advertisement. The user may then download the music (e.g., by following a link to the content) and/or may continue to the storefront (e.g., by following a link). With each event, the user may be credited with points. Moreover, in the example where the user downloads content, the user may be presented with another advertisement during the download and may be credited with more points.

In each of the types of advertising methods, revenue from the advertisers may be generated by the operator of the system. The revenue schedule and amount may vary depending on the advertiser and the advertising method. Further, the viewing and/or listening to advertising may occur while the user is doing one of the many activities offered by the system. For example, the user may choose to watch an advertising video clip while uploading content or while trading digital content with a friend.

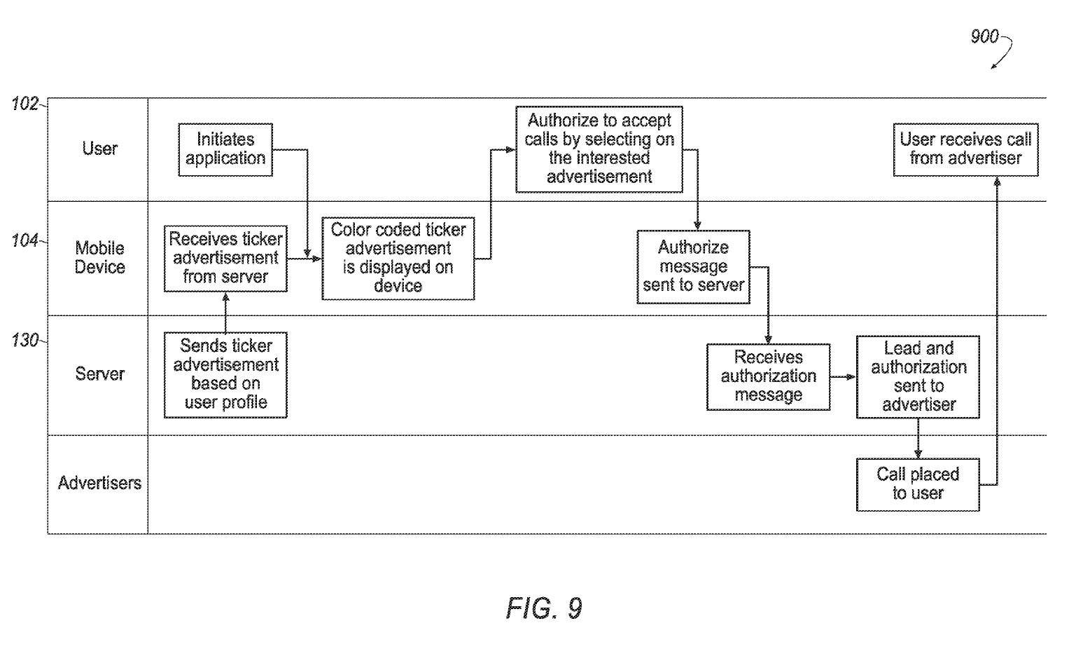

The system and methods described herein contemplate a point-based system where users can buy, gain, and use points for designated activities provided by the system. FIG. 10 is a diagram of a points system 1000 for use with the system and methods described herein. For example, viewing an advertisement can result in the user being credited points. Alternatively, the user could purchase points with real currency. These points can then be used to pay another user in exchange for the trade of a song. In one example, the system may be entirely point-driven such that users are initially prompted with activities to gain points or use points as payment for the activity and/or content.

With reference to FIG. 10, general points management actions are shown (see also point management system 224 of FIG. 2). A user may view points balances on a server using process 1010. This allows the user to determine how many points have accumulated to their account in real-time. However, viewing points on the server alone does not include points that may be on the mobile device. To view a point balance that shows the point balance on a mobile device, process 1012 is used by the user on their mobile phone to access the local points balance.

Point redemption actions 1020 may include purchasing more storage for the user's locker. The examples as explained herein for the usage of points are only some examples of potential uses. In general, points may be redeemed for intangible and tangible goods and/or services. In one example, the user may redeem X points for 1 MB of storage space (e.g., redemption of 5 points increases the users storage by 1 MB). When storage allocations are redeemed of a generally large size, there may be a volume discount or it may be a flat rate for storage (e.g., Y points for 5 MB or storage and Z points for 25 MB of storage).

Alternatively, the user may redeem points for the trading of content. In one example, the user may trade content at a rate of 1 point per content trade. This allows the user to increase their content by using points, rather than real money for purchase. In another option, the user may redeem points for gift cards. The gift cards may be used at merchants, retailers, or tickets to movies or events (concerts). For example, a user may redeem 150 points to obtain two movie passes. Another example could be redemption of 250 points for a $25 gift card to a retailer.

In general, points may be obtained in a variety of ways and some are shown at point acquisition actions 1030. The methods and circumstances of obtaining points as discussed herein are not intended to be limiting as they are merely examples of how users obtain points. A user may purchase points using currency (e.g., US Dollars), they may obtain points through sharing of the application (e.g., a friend downloads mobile client 214 and registers for service), they may obtain points through promotions (e.g., signing up for the service), or through trading. Other examples of how a user may obtain points includes following a link from provided by an advertisement (e.g., to a website), placing a phone call provided by an advertisement, downloading content provided by an advertisement (e.g., a ringtone, a background image, music content, or a video or further advertisement clip), providing advertisement information or a link to advertisement to another user, promotional campaigns, or other marketing or trading activities.

A user may receive points through trading of content when another user downloads their content. For example, user A may search and located content from user B. User A then may watch an advertisement or use points to download user B's content to their own locker. When content is traded, user B then may receive points based on the nature of the transaction. In an example of music sharing, user B may receive 5 points when user A downloads the music content. However, the points for a transaction may change based on the content traded (e.g., movie content may have different points than music content or data content). Additionally, the points for a trade may vary based on the license agreement with a copyright holder.

Points management actions 1040 may be employed by the user to deposit or withdraw points from their account. Such actions are similar to banking operations. However, the deposit and withdraw are performed on points rather than money.

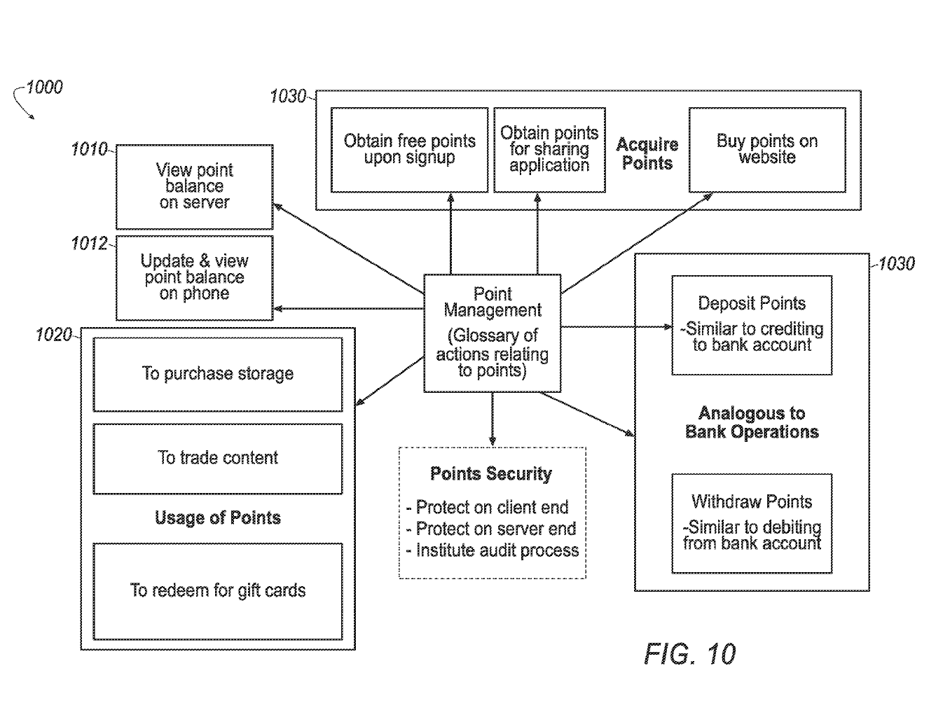

FIG. 11 is an architecture for “one click” digital content transfer system 1100. A user may initiate browsing a list of content 1110 from a user portal 1112 at a partner site 1114. Such browsing may include searching for digital content or viewing web-pages that contain information about digital content with the ability to connect the user with the digital content. The user may then select the digital content 1120. Selection of content may be, for example, by clicking a button from the click a button provided by partner site 1114. The button, or other selection mechanism, includes an identifier for the digital content (e.g., a serial number, location, or other indicator as to the digital content's uniqueness). Selection of digital content 1120 may be, for example, by way of clicking a button that will initiate the downloading to the user's mobile device.

When the user selects digital content 1120, the user's portal 1112 contacts 1130 the download facilitation services 1132 to initiate download to the user's mobile device. The user's portal 1112 sends the unique identifier for the digital content as provided by partner site 1114 (e.g., via the button). Download facilitation services 1132 then sends a download message 1140 to the user's mobile device 1142. Download facilitation services 1132 include, for example, a load balancer 133 to spread communications and downloads to multiple servers 1134, application repositories 1136, and content servers 1138, among other services. It is contemplated that download facilitation services 1132 may be embodied in a single device at one location, multiple devices at one location, or multiple devices at many locations.

Download message 1140 may include a link or identifier to initiate download to the user's mobile device 1142. For example, mobile device 1142 may receive an SMS message with source location, source identifier, and/or authentication information to allow mobile client 214 (see FIG. 2) to connect with content download facilitation services 1132 to download the digital content. Alternatively, information to facilitate download of the digital content may be send to mobile device 1142 via a proprietary messaging system and/or a web-application.

The user initiates transfer 1150 of the digital content by clicking or activating the link provided by download message 1140. Download facilitation services 1132 then connects with partner site 1114 to request the content 1160 specified by the user. In this example, partner site 1114 contains the persistent storage for the content. However, in other examples partner site 1114 may simply identify the digital content so that another storage system may provide the digital content. However, since in this example partner site 1114 stores the digital content, partner site 1114 sends 1170 the digital content to download facilitation services 1132. Upon requesting the content 1160, sending the digital content 1170, or after either requesting 1160 or sending 1170, download facilitation services 1132 may collect tracking information 1172 about the digital content, metadata, or other information to identify the digital content. This tracking information, as discussed herein, may be used to properly identify the digital content and to credit the appropriate entities with the transfer.

In another example, mobile client 214 may initiate 1150 downloading of digital content automatically. Such a system may be setup as a configuration of mobile client 214 such that when download message 1140 arrives, mobile client 214 automatically initiates 1150 download. This may be useful for the user where user interaction is not desirable. For example, when the user is browsing phone at portal 1112 and does not wish to use mobile device 1142 at the same time, or for example, when mobile device 1142 is not available.

Mobile client 214 (see FIG. 2), from mobile device 1142, then connects to download facilitation services 1132 to initiate 1150 authenticate/download the digital content. Download facilitation services 1132 then delivers 1180 the digital content to mobile device 1142. As can be seen herein, a single click from the user (e.g. at initiation of transfer 1150) provides the digital content to the user's mobile device 1142. Such a single click or “one click” approach minimizes the user's time, effort, and complexity to obtain the digital content.

In the context of the above system 1100, advertisements may be inserted at various times to provide revenue streams. Examples include providing the user with advertisements at any stage in the process, including selecting the digital content 1120, contacting 1130 the download facilitation services 1132, downloading message 1140, initiating transfer 1150, requesting the digital content 1160, sending the digital content 1170, or delivering 1180 the digital content.

Additionally, the system may include advertisement(s) during download and/or before the digital content is accessed by the user. In a system where the advertisement is shown before first use, the user may not be required to watch an advertisement to download the digital content, but rather would be required to watch an advertisement before accessing the digital content.

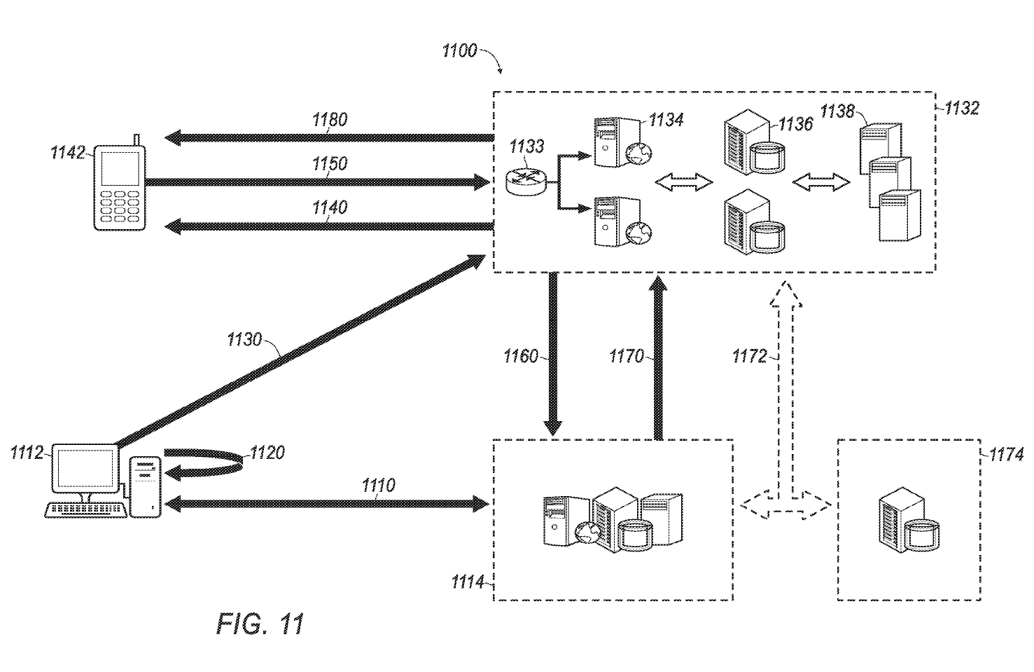

FIG. 12 is a flow chart for a “one click” model for digital content transfer method 1200, which is discussed in view of the system 1100 of FIG. 11 (discussed above in detail). In step 1210, the user browses a partner site 1114 and may select content for download. Once content is determined, the control proceeds to step 1120.

At step 1220, the user selects 1120 the digital content. Selection of content may be, for example, by clicking a button from the click a button provided by partner site 1114. The button, or other selection mechanism, includes an identifier for the digital content (e.g., a serial number, location, or other indicator as to the digital content's uniqueness). Selection of digital content 1120 may be, for example, by way of clicking a button that will initiate the downloading to the user's mobile device. Control proceeds to step 1230.

At step 1230, portal 1112 contacts 1130 the download facilitation services 1132 to initiate download to the user's mobile device. The user's portal 1112 sends the unique identifier for the digital content as provided by partner site 1114 (e.g., via the button). Control then proceeds to step 1240.

At step 1240, download facilitation services 1132 sends a download message 1140 to the user's mobile device 1142. Control then proceeds to step 1250.

At step 1250, the user or mobile agent 215 (see FIG. 2) may initiate transfer 1150 of the digital content. The initiation of transfer may be asynchronous from selecting 1120 the digital content in that the message transfer need not be performed close in time with selecting 1120. However, a system may be configured to include a timeout or other mechanism to remove or de-authorize download message 1140 (e.g., arbitrarily set, 30 minutes, 1 day, 30 days, 1 year, etc.). Such initiation may include the clicking of a link, responding to a message, or it may be automatic and initiated when mobile agent 215 receives download message 1140. Upon initiation of transfer 1150, an advertisement may be shown to the user. Control then proceeds to step 1260.

At step 1260, download facilitation services 1132 connects with partner site 1114 to request the content 1160 specified by the user. Alternatively, download facilitation services 1132 may contact another server, repository, or service to request the content 1160. Such a system may be useful where partner site 1114 is a distributed system or uses separate systems for storage of content. In another example, download facilitation services 1132 connects with partner site 1114 and partner site 1114 may operate as a pass-through or redirector to a provider that can serve digital content. Control then proceeds to step 1265.

At step 1265, an advertisement is shown to the user. Only after the advertisement is viewed will the downloaded content be released to mobile device 1142. Alternative examples include advertisements shown at various locations through method 1200. Control then proceeds to step 1270.

At step 1270, partner site 1114 (or other source/server) sends 1170 the digital content to download facilitation services 1132. Control then proceeds to step 1272.

At step 1272, download facilitation services 1132 (or another service) may collect tracking information 1172 about the digital content being sent 1170 to download facilitation services 1132. Control then proceeds to step 1280.

At step 1280, digital content is delivered 1180 to mobile device 1142.

In the context of the above system 1100, advertisements may be inserted at various times to provide revenue streams. Examples include providing the user with advertisements at any stage in the process, including selecting the digital content 1120, contacting 1130 the download facilitation services 1132, downloading message 1140, initiating transfer 1150, requesting the digital content 1160, sending the digital content 1170, or delivering 1180 the digital content. Additionally, the system may include advertisement(s) during download and/or before the digital content is accessed by the user. In a system where the advertisement is shown before first use, the user may not be required to watch an advertisement to download the digital content, but rather would be required to watch an advertisement before accessing the digital content. Such advertisements may be inserted to viewing by the user on mobile device 1142 and/or portal user 1112.

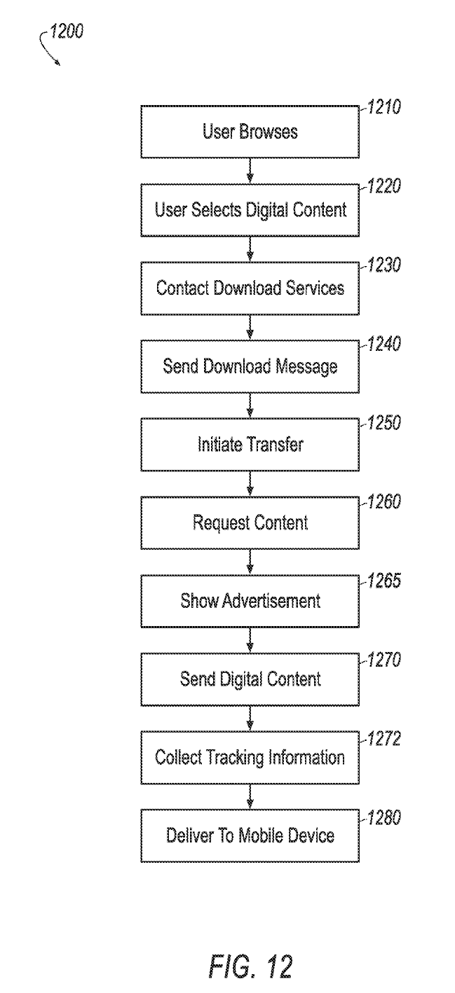

FIG. 13 is a multi-site architecture 1300 for a multi-site digital content transfer system. Architecture 1300 includes a similar architecture to FIG. 11. However, there are multiple partner sites 1114A, 1114B, 1114C, that user portal 1112 may connect with. Using the buttons, as described herein with respect to FIGS. 11-12, the user may select digital content from any number of partner sites 1114A, 1114B, 1114C and download the digital content directly to their mobile device 1142. Using a system of multiple sites to provide digital content, or identifying digital content, the user may visit any number of sites offering digital content and is not necessarily limited to a single-site. Moreover, allowing for downloads via identification of the digital content (e.g., using buttons with identifying information) the content providers may easily and quickly implement systems to provide digital content to users and/or purchasers. Such a system also allows the digital content provider to be independent of the single-site or single-source content providers and maintain control over digital content repositories, identification, and tracking of downloads, among other information.

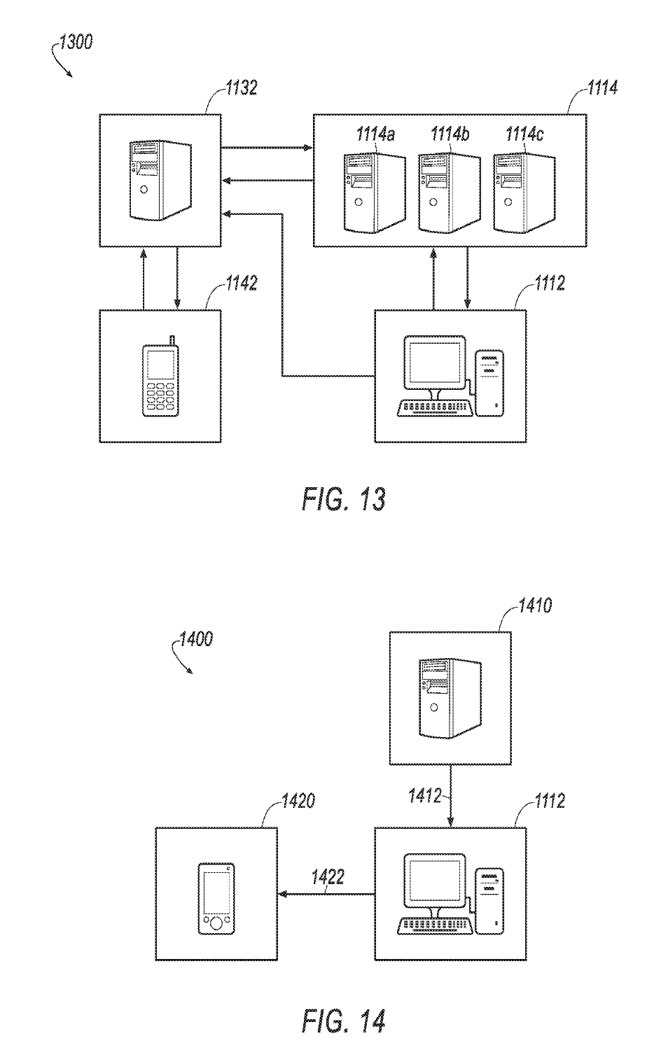

FIG. 14 is a single-site architecture 1400 for a single-site digital content transfer system. In comparison to multi-site architecture 1300, single-site architecture 1400 provides a single site 1410 for access by user portal 1112. Moreover, as shown in FIG. 14, the user must transfer digital content 1412 from single site 1410 to user portal 1112, and then transfer the digital content from user portal 1112 to media player 1420. Thus, single-site architecture does not provide for direct downloading to a mobile device.

As discussed herein, the embodiments use a storage system, a trading system, and a royalty tracking and payment system. However, each of the systems described may be used in conjunction with each other, could be used separately, or could be used in other applications. Additionally, other functionality not described herein may be added without straying from the scope of the embodiments. For example, the ability to broadcast messages to all or certain users of the system, a news, stock, and sports score feed option, download and registration process, and the ability to share or send the system software to another user are examples of additional functionally that may be implemented. Moreover, the system contemplates the use of streaming content rather than the trading of digital media. Thus, a user may wish to listen to music at a much-reduced rate or to determine whether the music should be purchased. As such, these examples are merely examples of how functionality may be expanded and are not meant to limit the scope of the foregoing disclosure.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1-20. (canceled)

21. A method, comprising the steps of:
providing web-page content having a web-page user-selectable button, wherein the web-page user-selectable button includes digital content identifying information and whereupon a user clicking on the user-selectable button, an initiation of a one-click digital content transfer process is conducted and includes the steps of:
selecting digital content;
sending a download message to a mobile device;
sending a message from said mobile device using information from said download message to a download facilitation service;
initiating transfer from a portal of said download facilitation service; and
transferring said digital content to said mobile device.

22. The method of claim 21, further comprising:
providing an advertisement to said first mobile device before completion of said transferring.

23. The method of claim 21, further comprising:
providing an advertisement to said first mobile device before sending said download message to said mobile device.

24. The method of claim 21, further comprising:
providing an identifier for said digital content with said download message.

25. The method of claim 21, further comprising:
requesting content from a content provider from said download facilitation service.

26. The method of claim 21, further comprising:
collecting information related to said digital content.

27. The method of claim 21, further comprising:
browsing a site for said digital content.

28. A system, comprising:
a content site that provides web-page content having a web-page user-selectable button, wherein the web-page user-selectable button includes digital content identifying information;
a digital content repository, said digital content repository providing storage medium for storing digital content;
a first mobile device having a first mobile user interface accessible by said first mobile device;
a user portal that provides
means for browsing the web-page content of the content site, and, whereupon a user clicking on the user-selectable button, the user initiates a one-click digital content transfer process wherein the user may indicate digital content for download from a download facilitation service;
a first network connecting said first mobile interface with said download facilitation service;
a second network connecting said user portal with the content site and said download facilitation service, said download facilitation service providing a transfer system enabling the transfer of said digital content from said digital content repository to said first mobile user interface.

29. The system of claim 28, wherein said first network and said second network are the same network.

30. The system of claim 28, further comprising:
a transaction management system that tracks content transferred between said download facilitation service and said first mobile device.

31. The system of claim 30, further comprising:
an advertisement system that sends an advertisement to the recipient of said content transferred.

32. The system of claim 30, further comprising:
a content owner system that credits an owner of said transferred digital content between said first user and said second user, said content owner being identified by said transaction management system.

33. The system of claim 28, wherein said first network comprises a wireless network.
